(19) United States
(12) Patent Application Publication
(10) Pub. No.: US 2008/0007429 A1
(43) Pub. Date: Jan. 10, 2008

(54) Visibility condition determining device for vehicle

(75) Inventors: Naoki Kawasaki, Kariya-city (JP); Takayuki Miyahara, Kariya-city (JP); Yukimasa Tamatsu, Okazaki-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/820,224

(22) Filed: Jun. 18, 2007

(30) Foreign Application Priority Data
Jul. 4, 2006 (JP) 2006-184805
Sep. 25, 2006 (JP) 2006-259439

(51) Int. Cl. G08G 1/00

(52) U.S. Cl. 340/905

(57) ABSTRACT

A visibility condition determining device for a vehicle has a lighting device, an in-vehicle camera and an image processing unit. The lighting device is mounted on the vehicle and irradiates an outside of the vehicle with its light beam. The in-vehicle camera picks up an image including a transmission space through which the beam irradiated from the lighting device is transmitted in an imaging area, and including a non-irradiated area that is not directly irradiated with the beam in a background of the transmission space in the image. The image processing unit determines a visibility condition outside of the vehicle based on a brightness of the non-irradiated area in the image which is picked up by the in-vehicle camera when the lighting device irradiates outside of the vehicle.

### CROSS REFERENCE TO RELATED APPLICATION

This application is based on and incorporates herein by reference Japanese Patent Applications No. 2006-184805 filed on Jul. 4, 2006 and No. 2006-259439 filed on Sep. 25, 2006.

### FIELD OF THE INVENTION

The present invention relates to a visibility condition determining device for a vehicle.

### BACKGROUND OF THE INVENTION

As conventional vehicle drive assist systems, an adaptive cruise control system (ACC), a lane keeping assist system and the like are proposed. Sensors that are employed in the drive assist systems are, for example, a millimeter wave radar, a laser radar, or an in-vehicle camera. Among those sensors, the in-vehicle camera recognizes lane lines through image processing.

It is also proposed to recognize external environments of a moving vehicle, and automatically optimally drive lights or wipers to assist the ensuring of visibility. In this system, it is important to detect fog. For example, when fog is detected, fog lamps are turned on, high beams of headlamps are suppressed, or the optical axes of the headlamps are adjusted downward to improve the visibility of a vehicle driver. Also, it is also proposed that a top speed of the vehicle is suppressed, an inter-vehicle distance alarm is more sensitively set, or a leading vehicle is displayed on a display.

As a fog sensor, a visibility meter using a laser beam may be used as used on an airport or a road. Also, a fog detection system using a camera image may be located on a road. Both the visibility meter and the fog detection system depend on the road infrastructure, and are not used on routes where no such road infrastructure is located. Therefore, the in-vehicle fog sensor is required.

JP 8-122437A (U.S. Pat. No. 5,627,511) discloses one in-vehicle fog sensor. This sensor detects fog by using a projection beam of a laser radar for inter-vehicle distance measurement. However, many vehicles have only a built-in millimeter wave radar and a built-in image sensor, but have no built-in laser radar.

JP 11-278182A and JP 2001-84485A disclose a sensor that detects a fog condition in image processing by using an in-vehicle camera. In JP 11-278182A, tail lamps of a leading vehicle are extracted from a picture image taken by a color camera, and the existence of fog is determined according to the degree of blur of the tail lamps. In JP 2001-84485A, road signs, etc. are recognized to determine the definition of the sign in order to determine the performance of a camera sensor using the image processing beyond the fog.

However, it is impossible in JP 11-278182A to determine fog condition if there is NO leading vehicle. In JP 2001-84485A, road signs are required. Therefore, the visibility condition of fog cannot be determined by a single subject vehicle.

### SUMMARY OF THE INVENTION

The present invention has therefore an object to provide a visibility condition determining device for a vehicle, which is capable of determining the visibility condition by a single subject vehicle.

According to one aspect, a visibility condition determining device for a vehicle has a lighting device, an in-vehicle camera and an image processing unit. The lighting device is mounted on the vehicle and irradiates an outside of the vehicle with its light beam. The in-vehicle camera picks up an image including a transmission space through which the beam irradiated from the lighting device is transmitted in an imaging area, and including a non-irradiated area that is not directly irradiated with the beam in a background of the transmission space in the image. The image processing unit determines a visibility condition outside of the vehicle based on a brightness of the non-irradiated area in the image which is picked up by the in-vehicle camera when the lighting device irradiates outside of the vehicle.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a visibility condition determining device for a vehicle according to a first embodiment of the present invention;

FIG. 2 is a flowchart showing a visibility condition determining process executed in the first embodiment of the visibility condition determining device;

FIG. 3 is a flowchart showing a lamp lighting determining process executed in the visibility condition determining process;

FIG. 4 is a flowchart showing a scattered-beam detection area image extracting process executed in the visibility condition determining process;

FIGS. 5A and 5B are image illustrations showing examples of an image when a visibility condition is excellent;

FIGS. 6A and 6B are image illustrations showing examples of the image when the visibility condition is poor;

FIG. 7 is a graph showing a luminance gradient (brightness gradient) relative to pixel positions;

FIG. 8 is a graph showing a fog probability relative to gradient;

FIG. 9 is a flowchart showing a modification of the lamp lighting determining process executed in the visibility condition determining process;

FIG. 10 is a flowchart showing a visibility condition determining process executed in a second embodiment of the visibility condition determining device; and

FIG. 11 is a flowchart showing a lamp lighting state changing process executed in the visibility condition determining process of the second embodiment.

### DETAILED DESCRIPTION OF THE PREFERRED EMBODIMENTS

### First Embodiment

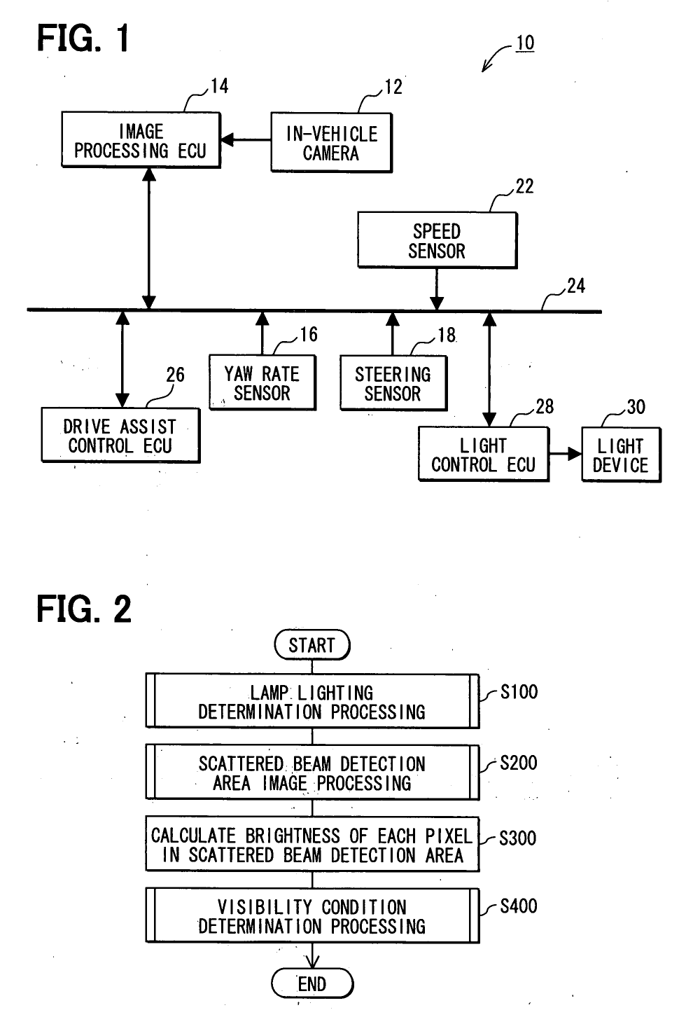

Referring first to FIG. 1, a visibility condition determining device 10 for a vehicle includes an in-vehicle camera 12, an image processing ECU 14, a yaw rate sensor 16, a steering sensor 18, and a vehicle speed sensor 22, which are connected to one another through an in-vehicle LAN 24. A drive assist control ECU 26 and a light control ECU 28 for a light device 30 are also connected to one another through the in-vehicle LAN 24.

The in-vehicle camera 12 may be a CCD camera made up of image pickup elements such as a CCD. The in-vehicle camera 12 is located above a mounting position HdLt of the light device (headlamp) 30 such as vehicle headlamps (not shown), and mounted, for example, in the vicinity of a rear-view mirror within a vehicle compartment.

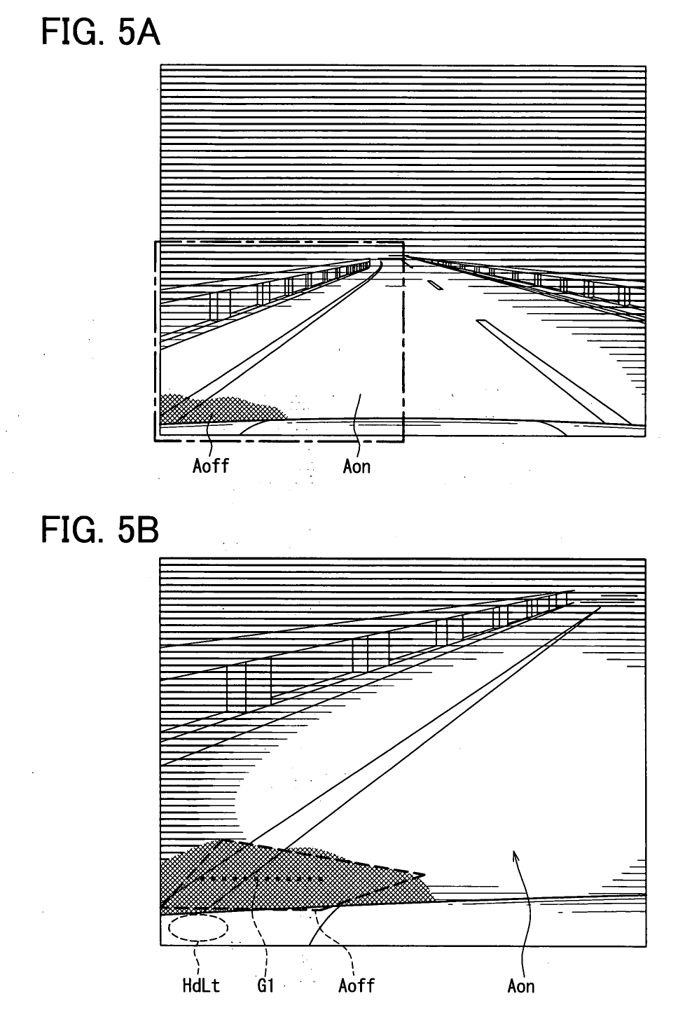

The in-vehicle camera 12 continuously picks up an image of a road in front of the vehicle as shown in FIG. 5A and FIG. 5B. FIG. 5B shows in enlargement an area indicated by a dot-chain line in FIG. 5A. Specifically the in-vehicle camera 12 takes an image that includes a transmission space through which beams irradiated from the headlamps are transmitted in an imaging area, and an image in which a background of the transmission space includes a non-irradiated area Aoff to which the beams from the headlamps are not directly irradiated as best shown in FIG. 5B. The non-irradiated area Aoff is indicated by a dotted line in FIG. 5B.

That is, as shown in FIG. 5B, the background of the transmission space on the image can be roughly classified into an irradiated area Aon to which beams are directly irradiated from the headlamps, and the non-irradiated area Aoff to which the beams are not directly irradiated from the headlamps. The in-vehicle camera 12 picks up the image including the non-irradiated area Aoff. The data of the image picked up by the in-vehicle camera 12 are processed in the image processing ECU 14.

The image processing ECU 14 includes a computer having a CPU, a ROM, and an RAM, and temporarily stores data of an image which is continuously picked up by the in-vehicle camera 12 for a given period of time in the RAM. The CPU executes a visibility condition determining processing shown in FIG. 2 with respect to the image data stored in the RAM.

The yaw rate sensor 16 detects a yaw rate of the vehicle, and the steering sensor 18 detects a steering angle of the steering. The vehicle speed sensor 22 detects a travel speed of the vehicle.

The drive assist control ECU 26 executes various controls of an off-lane alarm system that generates an alarm when the vehicle tends to cross a white lane marking (lane line) and deviate from the travel lane, and of a lane keeping assist system that makes the steering wheel generate a given steering torque so as to keep the vehicle within the lane.

The light control ECU 28 acquires a headlamp lighting switch signal through the in-vehicle LAN 24, and controls the on/off of the headlamps according to the headbeam lighting switch signal. The light control ECU 28 controls, as an adaptive front lighting system, the beam distribution of the headlamps according to the travel speed, the yaw rate, or the steering angle.

The image processing ECU 14 temporarily stores the data of the image from the in-vehicle camera 12, and subjects the image to given processing to execute lane line recognition processing for recognizing the lane line of the vehicle. The positional information on the lane line which is recognized by the lane line recognition processing is outputted to the drive assist control ECU 26.

The image processing ECU 14 according to this embodiment executes the visibility condition determination processing for determining the visibility condition outside the vehicle during traveling at night by using the in-vehicle camera 12 used for recognition of the lane line. In the visibility condition determination processing, the visibility condition outside of the vehicle is determined based on the brightness of the non-irradiated area Aoff shown in FIG. 5B as described above.

This is because a difference in the brightness occurs according to the visibility condition outside of the vehicle when the headlamps are turned on. More specifically, for example, if the visibility condition is excellent, because beams are not directly irradiated to the non-irradiated area Aoff from the headlamps, the brightness is frequently low as a whole.

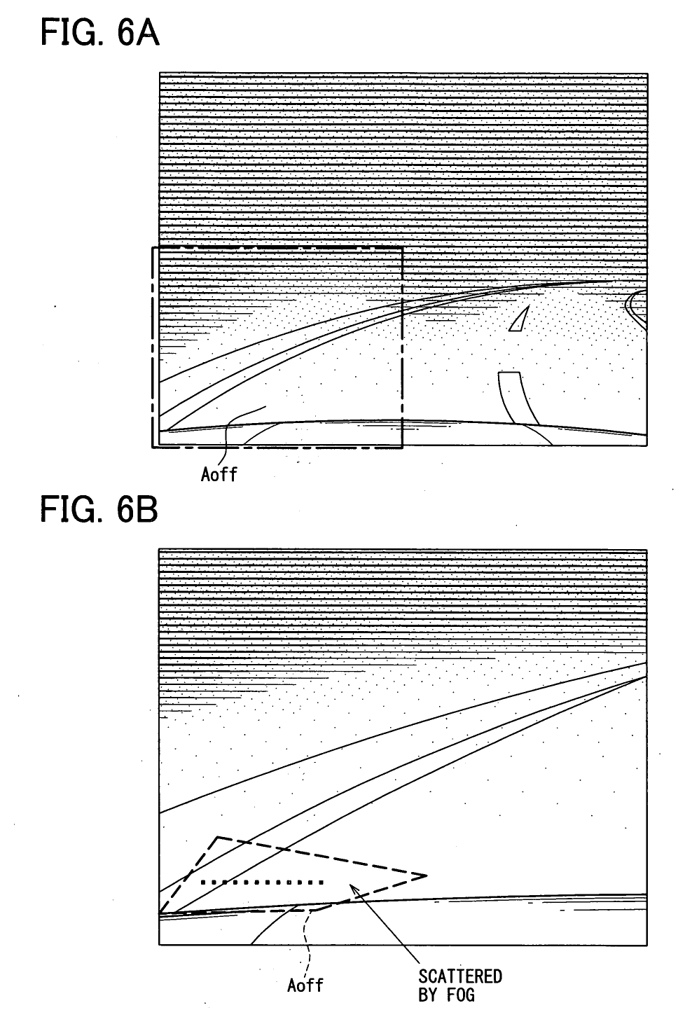

However, for example, when the occurrence of fog causes the poor visibility condition, the beams irradiated from the headlamps are scattered by fog particles although the beams from the headlamps are not directly irradiated to the non-irradiated area Aoff. As a result, as shown in FIGS. 6A and 6B, the scattered beams frequently cause the high brightness of the non-irradiated area Aoff as a whole.

As described above, the vehicle visibility condition determining device 10 takes into consideration the fact that the brightness of the non-irradiated area Aoff is different between a case where the visibility condition is excellent (no fog for instance) and a case where the visibility condition is poor (fog, for instance). Hereinafter, the non-irradiated area is referred to as a scattered beam detection area Aoff.

It is preferable that the in-vehicle camera 12 picks up an image including the transmission space closest to the headlamps in the imaging area among the transmission spaces through which the beams irradiated from the headlamps are transmitted, as shown in FIGS. 5B and 6B. This is because the difference in the brightness of the scattered beam detection area Aoff, which is attributable to the scattering of the irradiated beams due to the fog particles, notably occurs since the transmission space closest to the headlamps is closer in distance than the transmission space far from the headlamps.

The image processing ECU 14 executes a visibility condition determining processing as shown in FIG. 2. The visibility condition determination processing is executed in a given cycle, and an image in front of the vehicle is continuously picked up by the in-vehicle camera 12 during the execution of the visibility condition determination processing.

As shown in FIG. 2, the image processing ECU 14 first executes lamp lighting determination processing (S100). Then, the image processing ECU 14 executes scattered beam detection area image extraction processing (S200), and calculates the brightness of each pixel in the scattered beam detection area (S300). Thereafter, the image processing ECU 14 executes the visibility condition determination processing (S400).

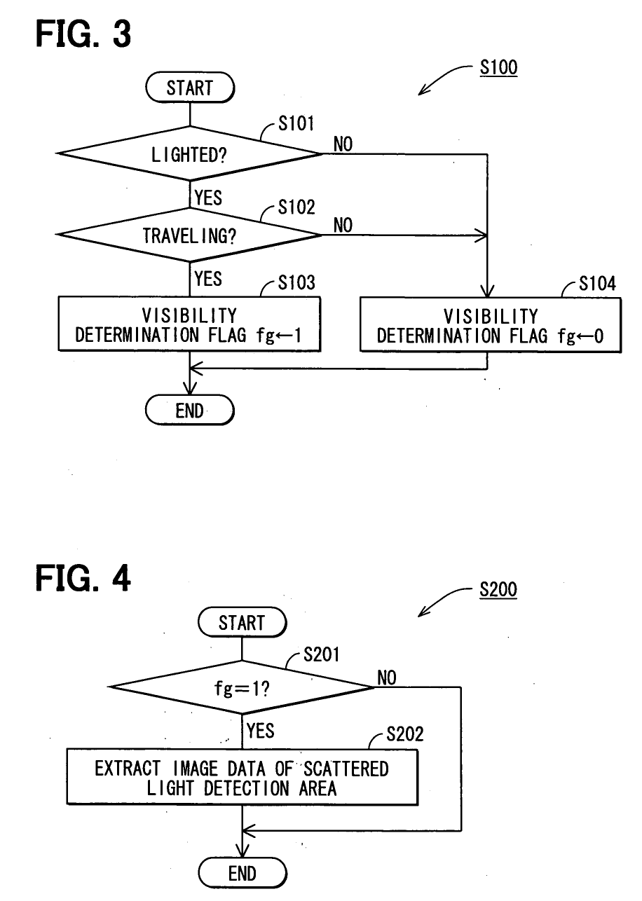

The lamp lighting determination processing of S100 will be described with reference to a flowchart shown in FIG. 3. It is checked in S101 whether the headlamps of the vehicle are turned on (lighted) or not. When the determination is YES in S101, processing is advanced to S102. On the other hand, when the determination is NO, processing is advanced to S104.

In S102, it is checked whether the travel speed of the vehicle is equal to or higher than a given speed indicative of vehicle traveling. When the determination is YES in S102, processing is advanced to S103. On the other hand, when the determination is NO, processing is advanced to S104.

In S103, “1” (determination execution) is substituted for a visibility condition determination flag fg to complete this processing. On the other hand, in S104, “0” (determination prohibition) is substituted for the visibility condition determination flag fg to complete this processing.

As described above, in the lamp lighting determination processing S100, when the travel speed of the vehicle is equal to or higher than the given speed, the visibility condition determination flag fg is set as “1” (determination execution) for the following reason. That is, in the case where the background of the transmission space on the image is a road, when the travel speed of the vehicle is extremely low (about several km/hour), an object on the road (for example, lane line) can be imaged in focus. As a result, an influence of the scattered beam detection area Aoff on the brightness is large. However, when the travel speed of the vehicle is higher than the extremely low speed, the object on the road is imaged in the blur. As a result, the background of the transmission space on the image becomes substantially even, and the influence of the scattered beam detection area Aoff on the brightness is small.

The scattered beam detection area image extraction processing of S200 is shown in FIG. 4. In S201, it is checked whether the visibility condition determination flag fg is “1” or not. When the determination is NO in S201, the determination of the visibility condition is prohibited and this processing is completed.

On the other hand, when the determination is YES in S201, the image data of the scattered beam detection area Aoff is extracted in S202. The position of the scattered beam detection area Aoff on the image is set in advance. In this embodiment, as shown in FIG. 5B, data of the respective pixels g1 that are continuous from the outside toward the inside within the image is extracted of the pixels included in the scattered beam detection area Aoff.

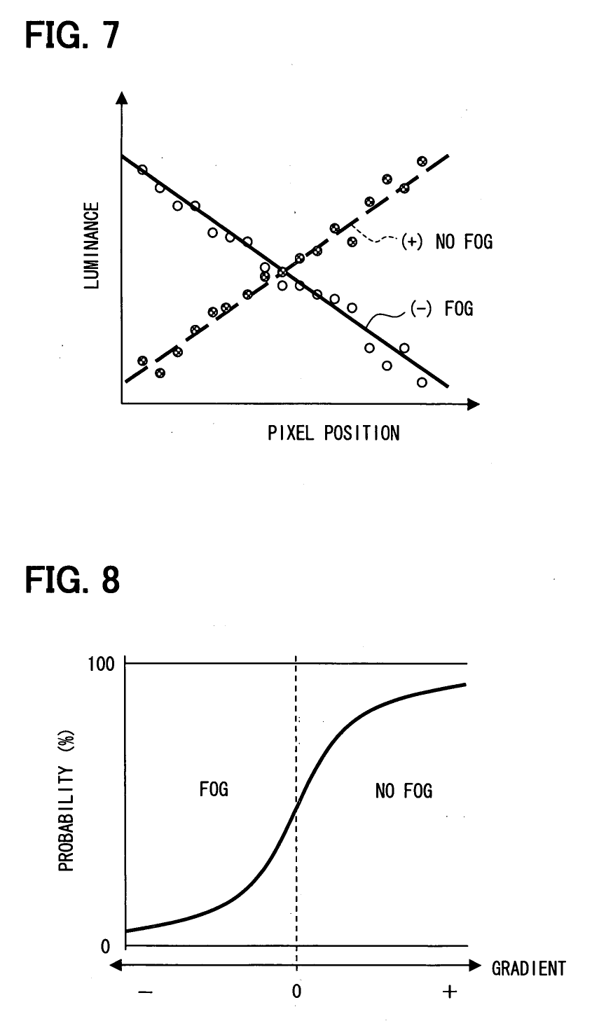

In S300 of FIG. 2, calculation is made to convert the pixel values of the respective pixels g1 that are extracted in S200 into luminance values. In S400, as shown in FIG. 7, a luminance gradient (a brightness gradient) that indicates a change rate of the luminance values of the respective pixels g1 is calculated by using the luminance values of the respective pixels g1 which are calculated in S300. The luminance gradient thus calculated is used to estimate the probability that the outside of the vehicle is foggy (non-foggy) bay the use of a predetermined fog probability characteristic shown in FIG. 8.

FIG. 7 is a graph with the respective pixels g1 that are directed from the outside toward the inside within the image as the axis of abscissa and the luminance values of the respective pixels g1 as the axis of ordinate. In this embodiment, a positional relationship between the headlamps and the in-vehicle camera 12 satisfies a relationship in which the in-vehicle camera 12 is located at a higher position of the vehicle than the position of the headlamps in the vertical direction, and close to the center of the right and left headlamps (in the vicinity of the rear-view mirror). In the case of the above positional relationship, the luminance values of the respective pixels g1 that are included in the scattered beam detection area Aoff changes from the outside toward the inside within the image when the visibility condition is excellent and poor.

For example, when the visibility condition is excellent (no fog), because the beams are not directly irradiated to the scattered beam detection area Aoff from the headlamps, the luminance values are frequently low as a whole, but there is a tendency to gradually increase the luminance values from the outside toward the inside within the image (positive luminance gradient).

On the other hand, for example, when the visibility is poor due to fog, the beams are not directly irradiated to the scattered beam detection area Aoff from the headlamps. However, because the beams irradiated from the headlamps are scattered by the fog particles, the luminance values of the scattered beam detection area Aoff are frequently high as a whole, which is attributable to the scattered beams. However, there is a tendency to gradually decrease the luminance values from the outside toward the inside within the image (negative luminance gradient).

Therefore, as shown in FIG. 7, it is determined that the visibility is poor (foggy) when the luminance gradient of the respective pixels g1 included in the scattered beam detection region Aoff is negative. On the other hand, it is determined that the visibility is excellent (non-foggy) when the luminance gradient is positive.

When an abnormal value is contained in the luminance values of the respective pixels g1 included in the scattered beam detection area Aoff, a linear characteristic shown in FIG. 7 may not be shown. In this case, for example, it is possible to remove the abnormal value by applying a known Least Median method.

In the visibility condition determination processing, the probability when the calculated luminance gradient is applied to the fog probability map shown in FIG. 8 is obtained, and fog probability information indicative of the probability of fog or no-fog, such as fog 60% (no-fog 40%) is outputted to the in-vehicle LAN 24.

The drive assist control ECU 26 that is connected to the in-vehicle LAN 24 executes control based on the fog probability information. For example, when the probability of fog is high, the drive assist control ECU 26 executes the control after the degree of reliability of the lane line recognition result is decreased by the lane departure alarm or the lane keeping assist. The light control ECU 28 executes control so as to change over to low beams, or executes control so as to automatically turn on fog lamps when the headlamps are high beams when the probability of fog is high.

In a vehicle on which an inter-vehicle distance control device that holds an inter-vehicle distance to a leading vehicle to a target inter-vehicle distance, for example, when the probability of fog is high, the inter-vehicle distance control device is capable of changing the target inter-vehicle distance to be longer than normal. Alternatively, for example, when the probability of fog is high, the inter-vehicle distance control device can limit the top speed of the vehicle.

As described above, the vehicle visibility condition determining device 10 according to this embodiment is capable of determining the visibility condition outside of the vehicle by the single subject vehicle because the headlamps that are mounted on the vehicle and the image that are up by the in-vehicle camera 12 are used.

### (Modifications)

The first embodiment may be modified as follows.

For example, in this embodiment, as shown in the lamp lighting determination processing of FIG. 3, the headlamps are being turned on as a precondition to execute the visibility condition determination. However, when the headlamps are being turned on, the degree of reliability of the visibility condition determination result is different depending on whether the fog lamps of the vehicle being turned on, or turned off at the same time.

That is, when the fog lamps are being turned off, and only the headlamps are turned on, the background of the non-irradiated area is dark, and the beams irradiated from the headlamps are irradiated to a narrow area. In this case, the brightness of the non-irradiated area is remarkably changed between the excellent visibility condition and the poor visibility condition, which is therefore in a state that is suitable for the determination of the visibility condition.

Accordingly, according to a first modification, in a state where the headlamps of the vehicle are turned on, and the fog lamps of the vehicle are turned off, it is determined that the state is suitable for the determination of the visibility condition. The degree of reliability of the determination result of the visibility condition when it is determined that the state is suitable for the determination of the visibility condition is high as compared with the determination result of the visibility condition which is conducted by the visibility condition determination processing when it is determined that the state is unsuitable for the determination of the visibility condition.

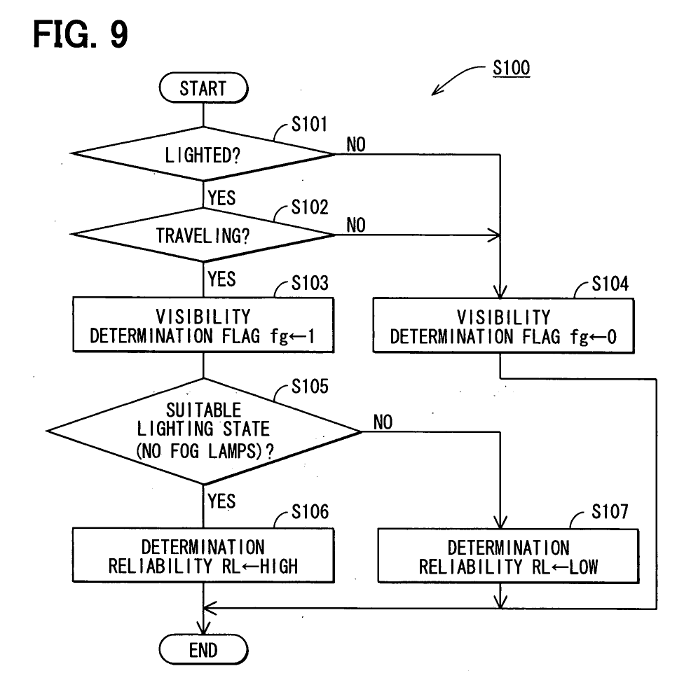

More specifically, the lamp lighting determination processing shown in FIG. 9 is executed as a modification of the first embodiment. S101 to S104 in FIG. 9 are similar in processing with those in the first embodiment, and therefore their description will be omitted. In S105, it is checked whether the lighting state is suitable for the determination of the visibility condition (a state in which the headlamps are turned on, and the vehicle fog lamps are turned off) or not. In this example, when the determination is YES (no fog lamps), the degree of reliability of the visibility condition determination RL is set as “high” in S106. On the contrary, when the determination is NO, the degree of reliability of the visibility condition determination RL is set as “low” in S107.

Then, in the visibility condition determination processing of Step 400 in FIG. 2, the degree of reliability of the visibility condition determination RL is added to the fog probability information (% value in FIG. 8) indicative of the probability of fog or non-fog, and then outputted to the in-vehicle LAN 24.

With the above processing, a difference may occur in the degree of reliability of the determination result of the visibility condition depending on whether the state being suitable for the determination of the visibility condition or not. As a result, when the control device that is different in the operation start timing according to a precision in the determination of the visibility condition is mounted on the vehicle, the response of the control device can be enhanced.

When the headlamps are turned on as the high beams, since the light beams from the headlamps are sufficiently strong, the state is more suitable for the determination of the visibility condition than the state when the headlamps are turned on as the low beams.

In the first embodiment, the visibility condition is determined from the luminance gradient of the respective pixels g1 that are included in the scattered beam detection area Aoff. However, as described above, when the visibility condition is excellent, the luminance values of the scattered beam detection area Aoff are frequently low as a whole. When the visibility condition is poor, the luminance values of the scattered beam detection area Aoff are frequently high as a whole.

Accordingly, according to a second modification, the visibility condition may be determined based on the brightness of one or more pixels that are included in the scattered beam detection area Aoff. For example, when the brightness of one or more pixels that are included in the scattered beam detection area Aoff is high, it is determined that the visibility condition is poor. When the brightness of one or more pixels that are included in the scattered beam detection area Aoff is low, it is determined that the visibility condition is excellent. As a result, a load of processing for determining the visibility condition is reduced.

Also, according to a third modification, the in-vehicle camera 12 is preferably mounted on the vehicle so that the background of the transmission space in the image becomes a chassis of the vehicle. This is because when the background of the transmission space in the image is even, an influence of the scattered beam detection area Aoff on the luminance value is small.

Also, in a night view device, an infrared ray is irradiated toward the front of the vehicle at the time of traveling in the night to display a pedestrian, another vehicle, an obstacle or a road status which is difficult to view inside or outside of the irradiated area of the headlamps. The in-vehicle camera having an image pickup device that senses the infrared rays may be employed. Therefore, according to a fourth modification, in the vehicle on which the night view is mounted, since both the lighting device that irradiates the infrared rays and the in-vehicle camera having the image pickup device that senses the infrared rays are mounted on the vehicle, it is possible to determine the visibility condition outside of the vehicle by using those existing devices without mounting an additional device.

When the in-vehicle camera that images the backside of the vehicle is located above positions at which a car registration plate lamp (license plate lamp) of the vehicle is installed, it is possible according to a fifth modification to determine the visibility condition outside of the vehicle based on the image that are picked up by the in-vehicle camera.

### Second Embodiment

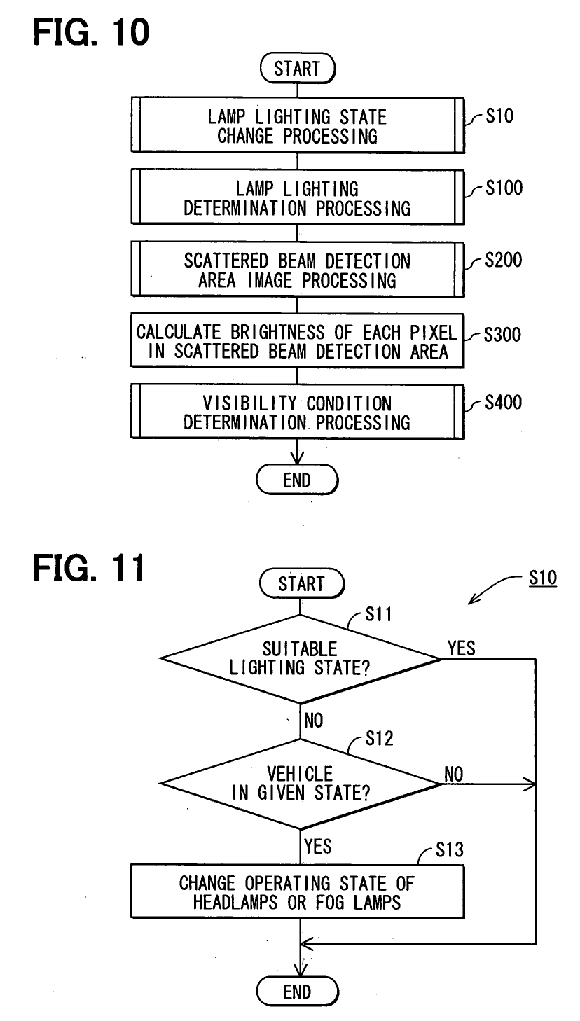

A vehicle visibility condition determining device 10 according to a second embodiment is different from that of the first embodiment in that a state that is suitable for the determination of the visibility condition is positively created by changing the light quantity or the optical axis direction of the headlamps or the fog lamps to determine the visibility condition. FIG. 10 is a flowchart showing visibility condition determination processing by means of the image processing ECU 14. This ECU 14 executes processing S10 followed by processing of S100, S200, etc. as shown in FIG. 10.

The lamp lighting state change processing S10 is shown in FIG. 11. Specifically, in S11, it is checked whether a lighting state is suitable for the determination of the visibility condition (a state in which the headlamps are turned on, but the vehicle fog lamps are turned off) or not. In this example, when the determination is YES, this processing is completed. When the determination is NO (that is, when it is determined that the state is improper for the determination of the visibility condition), processing is advanced to S12.

In S12, it is checked whether the vehicle state corresponds to a given state or not. In this example, the given state is directed to vehicle states when a subject vehicle or a leading vehicle that exists in front of the subject vehicle stops, after the vehicle starts moving, after the acceleration or deceleration of the vehicle is completed, and after lighting of turn signal lamps of the vehicle is terminated. It is checked whether the vehicle state corresponds to at least any one of those vehicle states or not. When the determination is YES in S12, the operating state of the headlamps or the fog lamps are changed in S13. When the determination is NO, this processing is completed.

As a result, the operating state of the headlamps or the fog lamps is changed at a timing, for example, when a subject vehicle or a leading vehicle that exists in front of the subject vehicle stops, after the vehicle starts moving, after the acceleration or deceleration of the vehicle is completed, and after lighting of turn signal lamps of the vehicle is terminated. As a result, it is possible to change turning on/off, the light quantity, and the optical axis direction of beams irradiated from the headlamps or the fog lamps at a timing when driver's attention is called to the front of the vehicle and at a timing when an influence on the driving operation is relatively small.

In S13, the operating state of the headlamps or the fog lamps is changed. That is, as described above, turning on/off, the light quantity, and the optical axis direction of beams irradiated from the headlamps or the fog lamps are changed. When the state is improper for the determination of the visibility condition, the operating state of the headlamps or the fog lamps is changed. As a result, even when the state is improper for the determination of the visibility condition, the state can be positively changed to a state that is suitable for the determination of the visibility condition. In order to suppress an influence on the driving operation as much as possible, it is desirable to temporarily change turning on/off, the light quantity, and the optical axis direction of beams irradiated from the headlamps or the fog lamps.

In S13, the low beams of the headlamps or the fog lamps are changed from an on state to an off state (or from the off state to the on state), the light quantity of the low beams of the headlamps or the fog lamps is adjusted, the optical axis direction of the low beams of the headlamps or the fog lamps is changed from the left (right) direction of the vehicle to the right (left) direction, or from the upper (lower) direction of the vehicle to the lower (upper) direction.

In the visibility state determination processing in S400 of FIG. 10, the brightness of the non-irradiated area before the operating state of the headlamps or the fog lamps is changed in the lamp lighting state change processing shown in FIG. 11 is compared with the brightness of the non-irradiated area after the operating state is changed to determine the visibility condition outside of the vehicle. In other words, the visibility condition is determined based on at least two images that have been picked up before and after the operating state of the headlamps or the fog lamps is changed.

The reason is stated below. That is, when the visibility condition is excellent, there is a small change in the brightness of the non-irradiated area, which is attributable to the change in turning on/off, the light quantity, and the optical axis direction of beams irradiated from the headlamps or the fog lamps. On the other hand, when the visibility condition is poor, there is a remarkable change in the brightness of the non-irradiated area, which is attributable to the change in turning on/off, the light quantity, and the optical axis direction of beams irradiated from the headlamps or the fog lamps.

In S400, when a difference between the brightness of the non-irradiated area before the operating state of the headlamps or the fog lamps is changed and the brightness of the non-irradiated area after the operating state of the headlamps or the fog lamps is changed reaches a given brightness difference or more, it is determined that the visibility condition is poor.

As described above, when the visibility condition is excellent, because the irradiated beams are not directly irradiated to the non-irradiated area, the brightness is frequently low. In addition, there is a small change in the brightness of the non-irradiated area, which is attributable to the change in turning on/off, the light quantity, and the optical axis direction of the low beams of the headlamps or the fog lamps.

On the contrary, when the visibility condition is poor, because the scattered beams are scattered in the non-irradiated area, the brightness is frequently high. In addition, there is a remarkable change in the brightness of the non-irradiated area, which is attributable to the change in turning on/off, the light quantity, and the optical axis direction of the low beams of the headlamps or the fog lamps. Accordingly, when there is the given brightness difference or more, it is determined that the visibility condition is poor. As a result, it is possible to improve a precision in the determination of the visibility condition.

The present invention can be implemented with further modifications.

What is claimed is:

1. A visibility condition determining device for a vehicle, the device comprising:
a lighting device that is mounted on the vehicle and irradiates an outside of the vehicle with a beam;
an in-vehicle camera that picks up an image including a transmission space through which the beam irradiated from the lighting device is transmitted in an imaging area, and including a non-irradiated area that is not directly irradiated with the beam in a background of the transmission space in the image; and
visibility condition determining means for determining a visibility condition outside of the vehicle based on a brightness of the non-irradiated area on the image which is picked up by the in-vehicle camera when the lighting device irradiates outside of the vehicle.

2. The visibility condition determining device as in claim 1, wherein:
the lighting device includes headlamps of the vehicle; and
the in-vehicle camera is located at a higher position of the vehicle than a position at which the lighting device is mounted, and installed to image a road in front of the vehicle.

3. The visibility condition determining device as in claim 1, wherein:
the lighting device includes a car registration plate lamp of the vehicle; and
the in-vehicle camera is located at a higher position of the vehicle than a position at which the lighting device is mounted, and installed to image backside of the vehicle.

4. The visibility condition determining device as in claim 1, wherein:
the in-vehicle camera picks up an image including the transmission space in proximity to the lighting device in the imaging area.

5. The visibility condition determining device as in claim 1, wherein:
the visibility condition determining means determines that the visibility condition is poor when the brightness of at least one pixel in the non-irradiated area of the image is higher than a predetermined value; and
the visibility condition determining means determines that the visibility condition is excellent when the brightness of at least one pixel included in the non-irradiated area of the image is lower than the predetermined value.

6. The visibility condition determining device as in claim 1, wherein:
the visibility condition determining means includes brightness gradient calculating means for calculating a brightness gradient indicative of a change ratio of the brightness of respective pixels, which is directed from an outside toward an inside within the image with respect to a plurality of pixels included in the non-irradiated area; and
the visibility condition determining means determines the visibility condition based on the brightness gradient that is calculated by the brightness gradient calculating means.

7. The visibility condition determining device as in claim 6, wherein:
the visibility condition determining means determines that the visibility condition is poor when the brightness gradient is negative, and determines that the visibility condition is excellent when the brightness gradient is positive.

8. The visibility condition determining device as in claim 1, wherein:
the lighting device irradiates infrared rays; and
the in-vehicle camera has an image pickup device that senses the infrared rays.

9. The visibility condition determining device as in claim 1, wherein:
the in-vehicle camera is installed so that the background of the transmission space in the image is a chassis of the vehicle.

10. The visibility condition determining device as in claim 1, further comprising:
speed detecting means for detecting a travel speed of the vehicle,
wherein the visibility condition determining means determines the visibility condition only when the vehicle travels at a given speed or higher.

11. The visibility condition determining device as in claim 1, further comprising:
light state determining means for determining whether a state is suitable for the determination of the visibility condition by the visibility condition determining means,
wherein the visibility condition determining means enhances the degree of reliability of the determination result of the visibility condition when the lighting state determining means determines that the state is suitable for the determination of the visibility condition as compared with the determination result of the visibility condition when the lighting state determining means determines that the state is unsuitable for the determination of the visibility condition.

12. The visibility condition determining device as in claim 1, wherein:
the lighting device includes irradiated beam change means for changing an irradiation state, which includes at least one of turning on/off, light quantity, and optical axis direction of the irradiated light; and
the visibility condition determining means determines the visibility condition based on a comparison result of the brightness of the non-irradiated area before the irradiated beam change means changes the irradiation state and the brightness of the non-irradiated area after the irradiated beam variable means changes the irradiation state.

13. The visibility condition determining device as in claim 12, wherein:
the visibility condition determining means determines that the visibility condition is poor when there is at least a given brightness difference between the brightness of the non-irradiated area before the irradiated beam change means changes the irradiation state and the brightness of the non-irradiated area after the irradiated beam change means changes the irradiation state.

14. The visibility condition determining device as in claim 12, further comprising:
lighting state determining means for determining whether the operating state of the lighting device is suitable for the determination of the visibility condition by the visibility condition determining means,
wherein the irradiated beam change means changes the irradiation state when the lighting state determining means determines that the irradiation state is unsuitable for determination of the visibility condition.

15. The visibility condition determining device as in claim 14, wherein:
the irradiated beam change means changes the irradiation state at least any one vehicle state of when the vehicle or a leading vehicle that exists in front of the vehicle stops, after the vehicle starts moving, after the vehicle completes acceleration or deceleration, and after completing lighting of turn signal lamps of the vehicle.

16. The visibility condition determining device as in claim 11, wherein:
the lighting state determining means determines that the state is suitable for the determination of the visibility state when the headlamps of the vehicle are turned on, and the vehicle fog lamps are turned off.
